(19) United States
(12) Patent Application Publication
(10) Pub. No.: US 2008/0272965 A1
(43) Pub. Date: Nov. 6, 2008

(54) COMBINATION OF PORTABLE COMPUTER AND ANTENNA

(76) Inventors: Sheng-Huang HSIA, Taipei (TW); Hsueh-Ping Yang, Taipei (TW)

Correspondence Address: HDSL, 4331 STEVENS BATTLE LANE, FAIRFAX, VA, 22033, US

(21) Appl. No.: 11/743,762

(22) Filed: May 3, 2007

(51) Int. Cl. H01Q 1/22

(52) U.S. Cl. 343/702

(57) ABSTRACT

A combination of a portable computer and an antenna includes a portable computer and an antenna. The antenna is mounted on the casing of the portable computer. The outer surface of the casing of the portable computer has a recessed region. The recessed region is provided with a plurality of protruding stripes therein. The antenna is composed of an outer plate, an antenna device and a sliding plate. The mounting surface of the sliding plate is provided with a plurality of sliding troughs each of which is combined with the corresponding protruding strip, so that the sliding plate can slide with respect to the portable computer. Via this sliding action, the user can adjust the position of the antenna, so that the portable computer can receive the wireless signals.

### BACKGROUND OF THE INVENTION

1. Field of the Invention

The present invention relates to an antenna, and in particular to an antenna that can be fixed on a portable computer.

2. Description of Prior Art

With the rapid development of the computer, the miniaturization of the hardware structure of the computer has also well developed and thus can be popularly applied to various fields. Even, the computer has become one of the sources of life entertainment. On the other hand, the rise and development of Internet also makes the computer to be used in every family more widely. Since the Internet is able to transmit information to everyplace all over the world, people can receive various kinds of information via the Internet. Thus, the computer has become an indispensable assistant in daily life.

During the development of the Internet, the mature development of the wireless technology and the miniaturization of the computer bring the capability of Internet to a nearly boundless extent. Therefore, with the transmission of wireless signals, people can use a portable computer to access the Internet and receive video/audio information at an indoor or outdoor site without being restricted by the existence of cables. In order to facilitate the portable computer device to receive the wireless signals completely, besides the support of hardware and software, it is necessary to provide an antenna to receive the wireless signals.

In the past, since a common portable computer is not provided with a suitable hardware for the wireless signal technology, an external antenna should be additionally provided to receive the wireless signals. Therefore, it is necessary for the user to carry an additional reception antenna so as to access the wireless Internet resource or receive other wireless signals. If the user forgets to carry the reception antenna with him, it is impossible to receive the wireless signals and thus cannot access the intended website. Further, another drawback of the reception antenna lies in that it occupies a USB port inevitably, which will become a trouble if the user needs more USB ports in the future.

The later-developed portable computer is additionally provided with a built-in antenna. Further, in order not to affect the external appearance of the portable computer, such a built-in antenna is usually hidden in a certain position within the computer. Although this solution can solve the inconvenience of the conventional reception antenna and does not occupy a connecting port, the angle of such kind of hidden antenna cannot be adjusted when the reception of signals is not good. Therefore, the user has to adjust the position of the portable computer so as to receive the wireless signals completely, which also causes a problem to the user.

### SUMMARY OF THE INVENTION

In view of the above drawbacks, the present invention is to provide a combination of a portable computer and an antenna that can be fixed on the computer. Via a movable antenna that can be mounted flatly and folded on the casing of the portable computer, the external appearance of the portable computer will not be affected. Further, the user can adjust the position of the antenna, so that the antenna can slide on the casing of the portable computer to a suitable distance. In this way, the user can receive the wireless signals at different places.

In order to achieve the above objects, the present invention provides a combination of a portable computer and an antenna, which includes a portable computer and an antenna. The antenna is provided on the casing of the portable computer. The outer surface of the casing of the portable computer has a recessed region. The recessed region is provided with a plurality of protruding stripes therein. The antenna is composed of an outer plate, an antenna device and a sliding plate. The mounting surface of the sliding plate is provided with a plurality of sliding troughs each of which is combined with the corresponding protruding strip, so that the sliding plate can slide with respect to the portable computer. Via this sliding action, the user can adjust the position of the antenna, so that the portable computer can receive the wireless signals.

### BRIEF DESCRIPTION OF THE DRAWINGS

FIG. 1 is an exploded perspective view showing the structure of the present invention;

FIG. 2 is an assembled view of the present invention;

FIG. 3 is a schematic view showing the operation of the present invention;

FIG. 4 is a perspective view showing the structure of another embodiment of the present invention; and

FIG. 5 is an exploded perspective view showing the structure of a further embodiment of the present invention.

### DETAILED DESCRIPTION OF THE INVENTION

The technical contents of the present invention will be described with reference to the accompanying drawings.

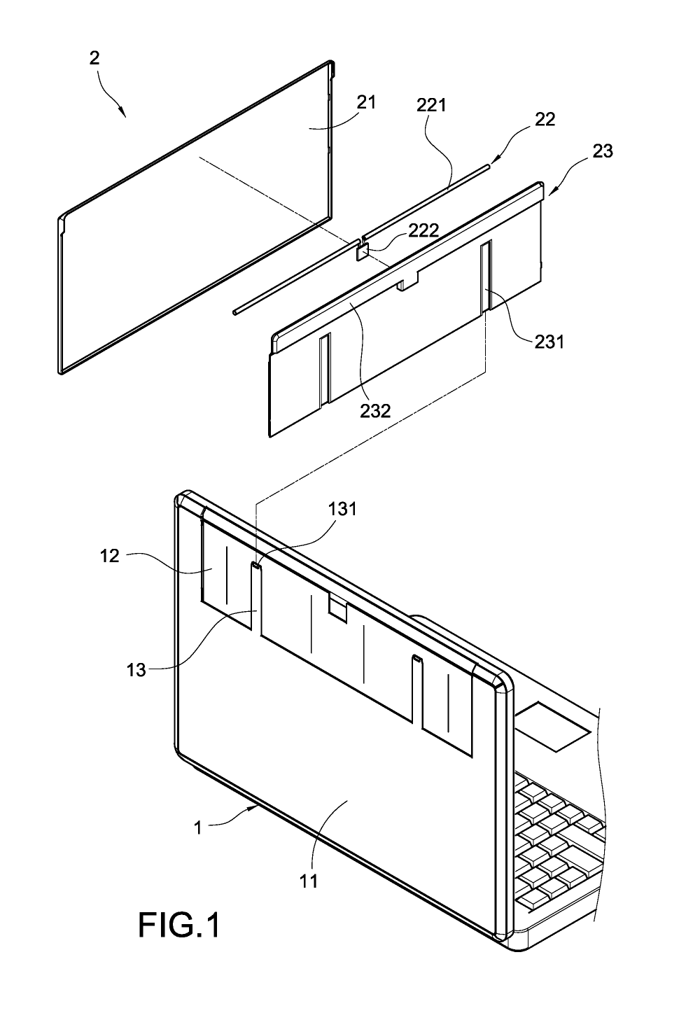

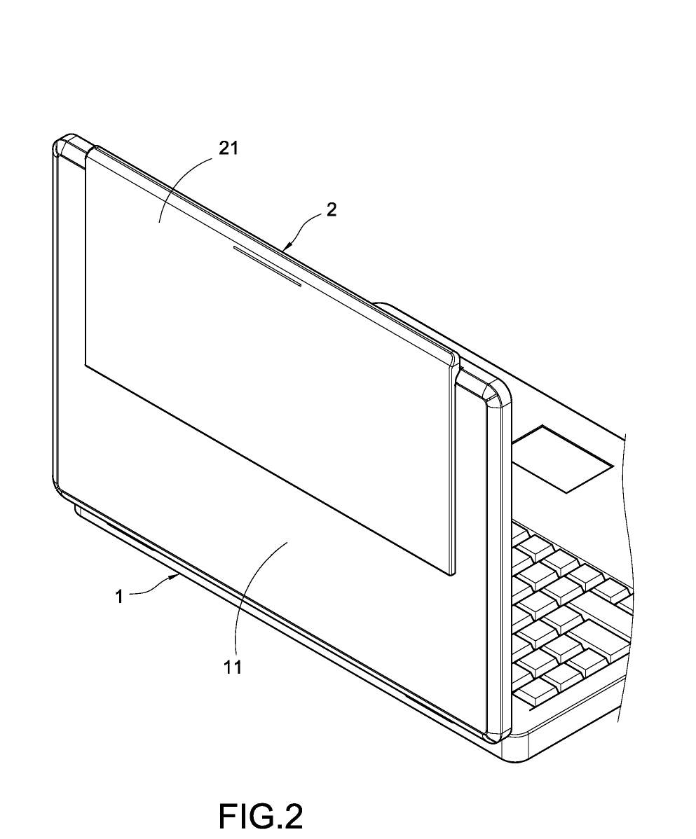

FIG. 1 and FIG. 2 are an exploded perspective view and an assembled view showing the structure of the present invention, respectively. As shown in these figures, the present invention includes a portable computer 1 and an antenna 2. The antenna 2 is mounted on the casing of the portable computer 1. The portable computer 1 has a screen 22. The outer surface of the casing is provided with a recessed region 12 at a position corresponding to that of the screen 11. The interior of the recessed region 12 is provided with a plurality of protruding stripes 13 that are arranged at intervals. The top end of the protruding strip 13 is provided with a protruding pillar 131. On the other hand, the external appearance of the antenna 2 is formed into a plate. The antenna 2 is comprised of an outer plate 21, an antenna device 22 and a sliding plate 23. The antenna device 22 is disposed between the outer plate 21 and the sliding plate 23. The antenna device 22 is comprised of a plurality of rod-like antennas 221 and an electronic element 222. The rod-like antenna 221 is electrically connected with the electronic element 222, thereby forming a region for receiving the wireless signals. The electronic elements 222 is electrically connected with the portable computer 1, so that the wireless signals received by the antenna device 22 can be transmitted to the portable computer 1. The sliding plate 23 is mounted into the recessed region 12 of the portable computer 1. The mounting surface of the sliding plate 23 is provided with a plurality of sliding troughs 231 thereon. Each sliding trough 231 is combined with a corresponding protruding strip 13, so that the antenna 2 can generate a sliding action. Further, the protruding pillar 131 provided on the top end of the protruding strip 13 is used to fix the rising position of the antenna 2. The top portion of the sliding plate 23 is provided with an accommodating trough 232 for accommodating the antenna device 22. The complete assembly of the present invention is shown in FIG. 2.

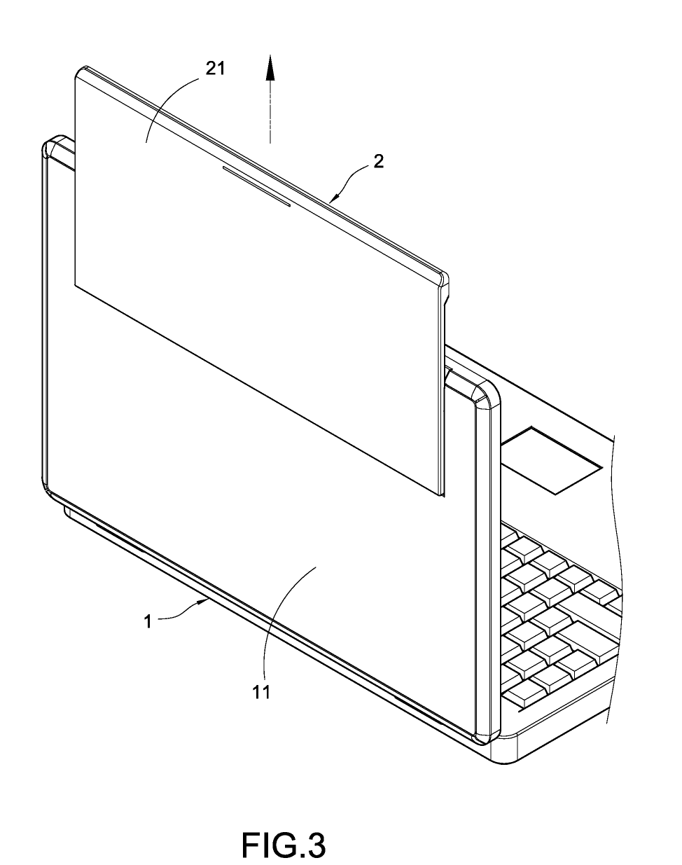

With reference to FIG. 3, it is a schematic view showing the operation of the present invention. As shown in this figure, when a user operates the portable computer 1, the antenna 2 acts to receive the wireless signals and transmits the signals into the portable computer 1. The user can put the antenna into its original position or raise it up according to the magnitude of the wireless signals received. When the antenna 2 is raised up as indicated by the arrow, with the sliding action between the sliding plate 23 and the casing of the portable computer 1, the antenna 2 can move upwardly until the protruding pillars 131 of the protruding stripes 13 engage with the sliding troughs 231, thereby fixing the position of the antenna 2. In this way, the portable computer 1 is located at an optimal position for receiving the wireless signals.

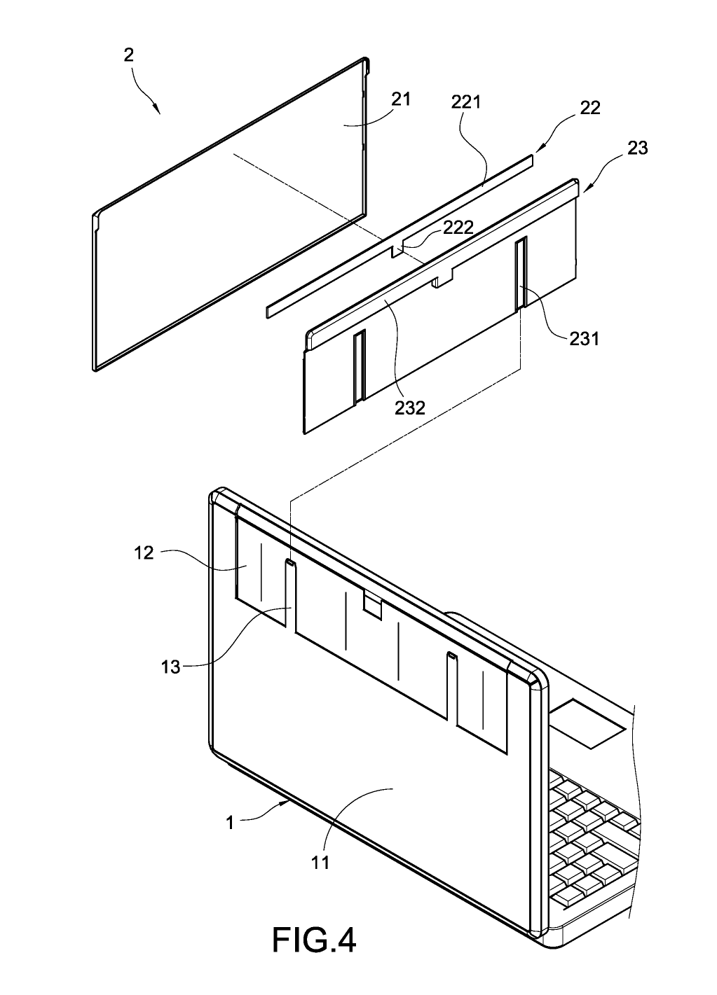

With reference to FIG. 4, it is a perspective view showing the structure of another embodiment of the present invention. In the previous embodiment, the antenna device 22 disposed between the outer plate 21 and the sliding plate 23 is composed of the rod-like antennas 221 and the electronic element 222. In addition, as shown in the figure of the present embodiment, the antenna device 22 is integrally formed into a flat T-lettered shape. The left and right ends of the antenna device 22 act as the regions for receiving the wireless signals. The bottom end of the antenna device 22 is electrically connected with the portable computer 1, thereby transmitting the received wireless signals to the portable computer 1.

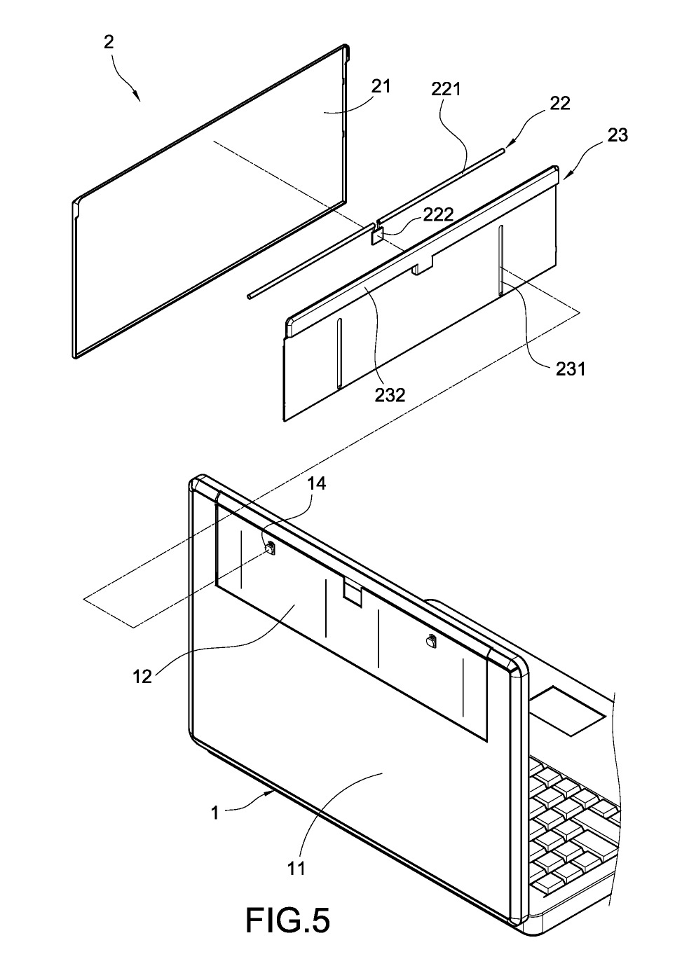

With reference to FIG. 5, it is an exploded perspective view showing the structure of a further embodiment of the present invention. In the previous embodiments, the antenna 2 is mounted on the portable computer with the sliding troughs 231 slidably connected with the protruding stripes 13 provided in the recessed region 12, so that the antenna 2 can slide with respect to the protruding stripes 13. Alternatively, as shown in this figure, the recessed region 12 is provided therein with fixing pillars 14 each of which is accommodated in the sliding trough 231 provided on the sliding plate 23. Via this arrangement, the sliding plate 23 can slide with respect to portable computer 1. Further, when the sliding plate 23 rises to the highest position, the fixing pillar 14 and the sliding trough 231 are engaged with each other, thereby fixing the sliding plate 23 to the highest position.

Although the present invention has been described with reference to the foregoing preferred embodiments, it will be understood that the invention is not limited to the details thereof Various equivalent variations and modifications may still occur to those skilled in this art in view of the teachings of the present invention. Thus, all such variations and equivalent modifications are also embraced within the scope of the invention as defined in the appended claims.

What is claimed is:

1. A combination of a portable computer and an antenna, comprising:
a portable computer; and
an antenna having an antenna device and a sliding plate, the antenna device being electrically connected with the portable computer for receiving wireless signals, one surface of the sliding plate being connected to a casing of the portable computer and being slidable with respect to the casing of the portable computer, the other surface of the sliding plate having an accommodating trough for accommodating the antenna device.

2. The combination of a portable computer and an antenna according to claim 1, wherein an outer surface of the casing of the portable computer has a recessed region, and the sliding plate is connected to the recessed region.

3. The combination of a portable computer and an antenna according to claim 2, wherein the recessed region is provided with a plurality of protruding stripes therein, a surface of the sliding plate that is correspondingly connected to the recessed region is provided with a plurality of sliding troughs, and each protruding strip is accommodated in each sliding trough.

4. The combination of a portable computer and an antenna according to claim 3, wherein a top portion of the protruding strip is provided with a protruding pillar for fixing a position of the sliding plate.

5. The combination of a portable computer and an antenna according to claim 2, wherein the recessed region is provided with a plurality of fixing pillars therein, the surface of the sliding plate that is correspondingly connected to the recessed region is provided with a plurality of sliding troughs, and each fixing pillar is accommodated in each sliding trough.

6. The combination of a portable computer and an antenna according to claim 1, wherein the antenna device comprises a plurality of rod-like antennas and an electronic element, and the rod-like antennas are electrically connected with the electronic element.

7. The combination of a portable computer and an antenna according to claim 1, wherein the antenna device is a plate-like antenna.

8. The combination of a portable computer and an antenna according to claim 7, wherein the antenna device is formed into a T-lettered shape.
